(19) United States
(12) Patent Application Publication
(10) Pub. No.: US 2009/0145868 A1
(43) Pub. Date: Jun. 11, 2009

(54) METHOD AND DEVICE FOR THE GROUPING OF CLOTHES HANGERS

(75) Inventor: Ralf SCHNEUING, Steinhagen (DE)

Correspondence Address: BARNES & THORNBURG LLP, 750-17TH STREET NW, SUITE 900, WASHINGTON, DC, 20006-4675, US

(73) Assignee: PEP FORDERTECHNIK GMBH, Bielefeld (DE)

(21) Appl. No.: 12/325,558

(22) Filed: Dec. 1, 2008

(30) Foreign Application Priority Data
Dec. 10, 2007 (DE) 10 2007 059 626.1

(51) Int. Cl. B65G 37/00; A47F 5/00

(52) U.S. Cl. 211/113; 198/465.4

(57) ABSTRACT

A method for grouping clothes hangers includes stopping a first one of a plurality of adapter hooks on a rail by a stopper, detecting a position of the first adapter hook by a sensor, permitting clothes hangers to be grouped adjacent to the first adapter hook, opening the stopper to permit the first adapter hook and clothes hangers to pass the stopper in a transport direction, and closing the stopper to permit stopping of a second one of the plurality of adapter hooks.

### CROSS-REFERENCE TO RELATED APPLICATION(S)

This United States Non-Provisional Utility Patent Application relies for priority on German Patent Application No. 10 2007 059 626.1, filed on Dec. 10, 2007, the contents of which are incorporated herein by reference.

### FIELD OF THE INVENTION

The present invention relates to a method and a device for the grouping of clothes hangers.

### DISCUSSION OF THE RELATED ART

In the storage and delivery of textiles, in particular of clothes items, it is necessary to combine groups of clothes hangers with corresponding clothes items, for example in order to deliver a certain collection to a trader. In order to form such groups of clothes hangers, it is known to provide separating hangers between the clothes hangers, which, specifically in smaller groups of clothes hangers, adversely affects the transport capacity. Moreover, errors can occur in the grouping, which can be rectified only with a great deal of effort.

### SUMMARY OF THE INVENTION

The object of the present invention is therefore to provide a method and a device for the grouping of clothes hangers, which reliably prevent errors and have a high transport capacity.

This object is achieved with a method and a device as described herein.

In the method according to the invention, an adapter hook is stopped in a transport motion (i.e., a transport or travel direction) by means of a stopper element, the position of the adapter hook then being detected via a sensor. The stoppage of the adapter hook causes clothes hangers that follow (or are subsequent to) to the adapter hook to be stowed up (i.e., collected) behind the adapter hook and, thus, be grouped. The stopper element is then opened and reclosed, so that the stopped adapter hook is moved onward in the transport direction and the stowed-up clothes hangers are moved together with the adapter hook. The clothes hangers, even in the closed position of the stopper element, may be transported past the latter until a following adapter hook is stopped by the stopper element. In other words, the clothes hangers may pass the stopper even if the stopper is in a closed position, so long as the preceding adapter hook has been released for movement in the travel direction. This procedure has the advantage that an erroneous grouping is prevented by the mechanical stoppage of an adapter hook. This is due to the fact that, among other reasons, the adapter hook assumes the function of a guide element, which groups the clothes hangers that follow it until a further (or subsequent) adapter hook follows. An adapter hook may then be stopped until such time as a following router or other handling device is appropriately actuated.

A large transport capacity can also be maintained in one contemplated embodiment of the invention, since the adapter hook itself can be adapted to carry (or contain) one or more clothes hangers.

According to one contemplated embodiment of the invention, the stopper element has two stops, which can be moved separately from each other. In this embodiment, the rear stop in the transport direction is only opened when the front stop is closed. This serves reliably to prevent the adapter hooks, even when they succeed one another, from being mutually separated by the device. As will become apparent with respect to this embodiment, when the front adapter hook is released by the rear stop in the transport direction, the front stop sees to it that the following adapter hook is stopped.

The device according to the invention for the grouping of clothes hangers comprises a stopper element, by means of which a moving adapter hook can be stopped, and a sensor for detecting whether an adapter hook is held at the stopper element. The stopper element has at least one movable stop, which, in the closed position, arrests an adapter hook, but grants passage to clothes hangers gathering behind the adapter hook. This is achieved by the adapter hook having a shape different than the following clothes hangers. In this respect, a mechanical stop detains the adapter hook, while the clothes hangers, due to a slimmer geometry, are permitted to pass. With simple means, it is hence possible to achieve an effective grouping of the clothes hangers, which are mutually separated by the individual adapter hooks.

In order reliably to prevent errors in the grouping of the clothes hangers, the stopper element can have two stops, which can be moved separately from each other. In one contemplated embodiment, the sensor for detecting the occupancy by an adapter hook is provided between the stops, the space between the stops being configured such that only one adapter hook can be inserted (or may be present at any given time). A control system can then ensure that at least one stop always remains in the closed position and that consecutive adapter hooks are likewise separated from one another.

According to one embodiment of the invention, the adapter hooks and clothes hangers are transported along a rail. The rail can be arranged obliquely (i.e., at an angle), for example, so that a motion of the adapter hooks and clothes hangers is realized by gravitational force and no separate drive means have to be provided.

The adapter hook may include a hook adjacent to a wall portion, which cooperates with the at least one stop of the stopper element. In this embodiment, the wall portion can project laterally and can be configured wider than the neck of a clothes hanger so as to be able reliably to perform a separation between adapter hook and clothes hanger.

The adapter hook may include, in one embodiment, a receiving fixture for the hanging of at least one clothes hanger. Hence, the adapter hook can also be used itself to transport clothes hangers, which optimizes the transport capacity.

According to a further embodiment, the adapter hook comprises at least one identification marking, for example a barcode or an RFID (radio frequency identification) chip. Information on the clothes items can hence be stored on the adapter hook and/or the following clothes hangers. Further information, such as the number of clothes hangers, etc., could also be stored, which, via a control system, may be expedient for the handling of a group of clothes hangers.

### BRIEF DESCRIPTION OF THE DRAWINGS

The invention is explained in greater detail below with reference to at least one contemplated embodiment, which is illustrated in the appended drawings, wherein:

FIG. 1 shows a view of a device according to the invention for the grouping of clothes hangers;

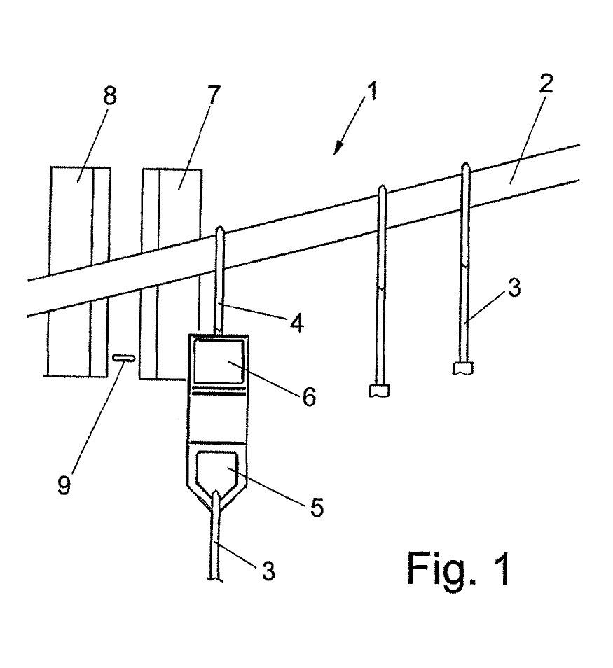

FIGS. 2A to 2D show several schematic views of the device for grouping clothes hangers in different transport positions, and

FIGS. 3A to 3C show several schematic views of an adapter hook for the device of FIG. 1.

### DESCRIPTION OF EMBODIMENT(S) OF THE INVENTION

The invention will now be described in connection with one or more embodiments. The discussion and illustration of particular embodiments is not intended to be limiting of the invention. To the contrary, the embodiments are intended to be exemplary of the broad scope of the invention.

A device 1 for the grouping of clothes hangers comprises a rail 2, which is inclined to the horizontal and on which clothes hangers 3 are hung and transported. The rail 2 has an inclination such that the clothes hangers 3 can slide along the rail 2 due to gravitational force. Between the clothes hangers 3, an adapter hook 4 is provided. The adapter hook 4 is used to group the clothes hangers 3. The adapter hook 4 has a marking 6 (e.g., an identification region or a label area) for identification purposes, for example, a barcode. Furthermore, the adapter hook 4 can alternatively or additionally also have an RFID chip or another marking means. The adapter hook 4 further includes a receiving fixture 5, from which one or more clothes hangers 3 can be hung.

In order to group the clothes hangers 3, a stopper element is provided, which has two mutually spaced stops 7 and 8. A sensor may be provided between the stops 7, 8 to detect the presence of an adapter hook 4.

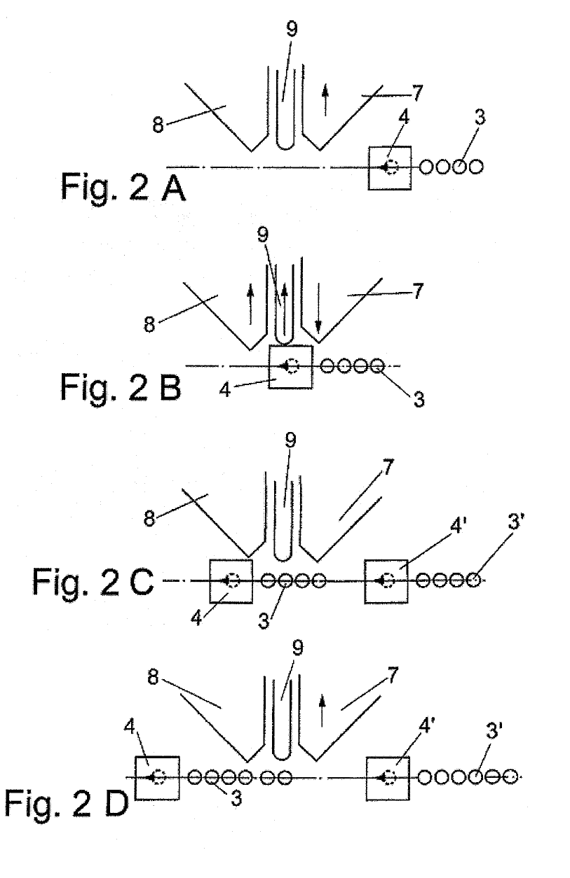

The method according to the invention for the grouping of clothes hangers 3 is explained in greater detail with reference to FIGS. 2A to 2D.

An adapter hook 4 moves in the transport direction along the rail and is followed by a plurality of clothes hangers 3 (FIG. 2A). The adapter hook 4 projects in a direction perpendicular to the transport direction. Moreover, the adapter hook 4 projects laterally over the hooks of the clothes hangers 3, which hooks are generally formed of a wire portion. Due at least in part to the construction of the adapter hook 4, the adapter hook 4 may be stopped by closure of the stops 7 and 8 of the stopper element. The construction is such that, even when the stops 7 and 8 on the stopper element are closed, the clothes hangers 3 are able to pass the stops 7, 8.

In a first step, the adapter hook 4 is stopped at the front first stop 7 and a check is made on whether the position between the two stops 7 and 8 in the region of the sensor 9 is free. If the position is free, the stop 7 is moved away from the rail 2, so that the adapter hook 4 can pass. As should be apparent from FIG. 2A, once the adapter hook 4 passes the stop 7, it moves up to the stop 8.

As can be seen in FIG. 2B, the sensor 9 is located between the two stops 7 and 8 and can detect the occupancy by the adapter hook 4. When the sensor 9 detects the presence of the adapter hook 4, the front stop 7 is moved into the closed position and the stop 8 is opened, where necessary with a certain time lag. As a result of the stoppage of the adapter hook 4, the clothes hangers 3 that follow (or are disposed behind) the adapter hook 4 are piled together and are now located closely behind the adapter hook 4.

When the second stop 8 is opened, the adapter hook 4 can pass, as can be seen in FIG. 2C. The clothes hangers 3 disposed behind the adapter hook 4 also are permitted to pass. The clothes hangers 3 have a narrow neck portion, which is so thin that the stops 7 and 8 themselves, in the closed position, do not prevent a motion of the clothes hangers 3. Rather, the clothes hangers 3, together with the adapter hooks 4, can be transported onward. According to one contemplated embodiment, the adapter hook 4 and the clothes hangers 3 can be moved to a packing bay or other handling bay. Should a following (or subsequent) adapter hook 4′ follow the first adapter hook 4 with the clothes hangers 3, movement of the subsequent adapter hook 4′ is arrested by the first stop 7. The first stop 7 remains in the closed position for as long as the sensor 9 establishes an occupancy by an adapter hook 4 and the stop 8 remains in the open position. Only after the adapter hook 4 is no longer present in the region of the sensor 9 and the stop 8 is in the closed position is the first stop 7 be opened (FIG. 2D). This prevents a subsequent adapter hook 4′ from inadvertently being moved with the first group of clothes hooks 3 and the adapter hook 4. The adapter hook 4′, with its associated clothes hangers 3′, is stopped between the stops 7 and 8 in the same manner that the adapter hook 4 was stopped. As indicated, the subsequent adapter hook 4′ is grouped with the following clothes hangers 3′ for further handling and/or processing.

In the represented illustrative embodiment, two stops 7 and 8, which can be moved separately from each other, are provided, between which a sensor 9 is arranged. This embodiment has the advantage that an erroneous grouping is reliably prevented. It is also possible, of course, by virtue of an appropriate control system, to use also only one stop for the grouping of clothes hangers.

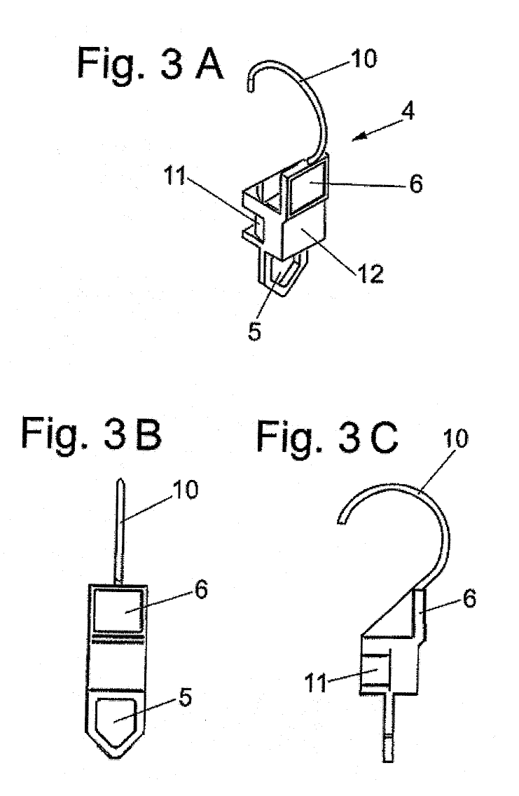

In FIGS. 3A to 3C, the adapter hook 4 is represented in detail. The adapter hook 4 comprises an upper hook 10, which can be hung from a rail 2. Instead of a thin neck portion, the adapter hook 4 comprises, however, a body 12, on which a coding 6, preferably a bar code, is arranged for identification purposes. The body 12 may be made from plastic or other suitable material. In addition, in the body 12, an RFID chip can be provided. On the body 12 a stop 11 is configured, which cooperates with the stops 7 and 8 of the stopper element. In the illustrated embodiment, the wall portion 11 projects laterally from a neck portion of the upper hook 10 and has a greater width than the wire hanger of following clothes hangers 3.

The adapter hook 4 further comprises a receiving fixture 5 in the form of an eyelet, in which one or more clothes hooks can be hung. The transport capacity of the device for the grouping of clothes hangers can thereby be optimized.

Other embodiments and variations should be apparent to those skilled in the art and are intended to fall within the scope of the invention.

1-9. (canceled)

10. A method for grouping clothes hangers, comprising:
stopping a first one of a plurality of adapter hook on a rail by a stopper;
detecting a position of the first adapter hook by a sensor;
permitting clothes hangers to be grouped adjacent to the first adapter hook;
opening the stopper to permit the first adapter hook and clothes hangers to pass the stopper in a transport direction; and
closing the stopper to permit stopping of a second one of the plurality of adapter hooks.

11. The method of claim 10, wherein the stopper comprises first and second stoppers, the first and second stoppers being moveable separately from one another, the second stopper being opened only when the first stopper is closed.

12. The method of claim 11, wherein the sensor is positioned between the first and second stoppers.

13. An apparatus for grouping clothes hangers, comprising:
a rail;
at least a first adapter hook disposed on the rail, wherein the clothes hangers follow the first adapter hook;
a stopper disposed adjacent to the rail to stop movement of the first adapter hook in a travel direction; and
a sensor disposed adjacent to the stopper to detect when the first adapter hook has been stopped by the stopper;
wherein the stopper has an opened position to permit the first adapter hook and the clothes hangers to move along the rail in the travel direction, and
wherein the stopper has a closed position to stop the first adapter hook and the clothes hangers from moving along the rail in the travel direction.

14. The apparatus of claim 13, wherein the sensor is operatively connected to the stopper.

15. The apparatus of claim 13, wherein the stopper comprises first and second stoppers disposed adjacent to one another along the travel direction and are moveable independently between the opened and closed positions.

16. The apparatus of claim 15, wherein the sensor is disposed between the first and second stoppers.

17. The apparatus of claim 13, wherein the first adapter hook comprises:
a hook; and
a wall portion connected to the hook, the wall portion being engageable with the stopper when in the closed position.

18. The apparatus of claim 17, wherein the wall portion comprises:
a receiving fixture for receiving at least one clothes hanger thereon.

19. The apparatus of claim 13, wherein the first adapter hook comprises an identification region, permitting identification of the first adapter hook.

20. The apparatus of claim 19, wherein the identification region comprises a label for optical identification of the first adapter hook.

21. The apparatus of claim 20, wherein the label comprises a bar code.

22. The apparatus of claim 19, wherein the identification region comprises a radio frequency identification tag for identification of the first adapter hook.
